(19) United States
(12) Patent Application Publication
(10) Pub. No.: US 2025/0341701 A1
(43) Pub. Date: Nov. 6, 2025

(54) FRAME MOUNTABLE MODULES WITH ADAPTERS FOR OPTICAL FIBER CONNECTORS

(71) Applicant: CommScope Technologies LLC, Hickory, NC (US)

(72) Inventors: Bart Mattie CLAESSENS, Hasselt (BE); Geert VAN GENECHTEN, Vorselaar (BE)

(73) Assignee: CommScope Technologies LLC, Hickory, NC (US)

(21) Appl. No.: 18/860,739

(22) PCT Filed: Apr. 28, 2023
(86) PCT No.: PCT/US2023/020423

§ 371 Date: Oct. 28, 2024

Related U.S. Application Data
(60) Provisional application No. 63/336,358, filed on Apr. 29, 2022.

(51) Int. Cl. G02B 6/44

(52) U.S. Cl. CPC G02B 6/44526

(57) ABSTRACT

Patch panel modules that can be mounted to a frame of an organizer of telecommunications equipment. In some examples, patch panel modules and fiber management tray support modules can be interchangeably mounted to module mounting locations defined by the frame.

### CROSS-REFERENCE TO RELATED APPLICATIONS

This application is being filed on Apr. 28, 2023, as a PCT International application and claims the benefit of and priority to U.S. Patent Application No. 63/336,358, filed on Apr. 29, 2022, the disclosure of which is hereby incorporated by reference in its entirety,

### TECHNICAL FIELD

The present disclosure relates to components of telecommunications equipment that can improve fiber management versatility and/or capacity.

### BACKGROUND

Optical fibers of telecommunications networks are managed at telecommunications equipment located at different network distribution locations. Such telecommunications equipment can include closures, cabinets, shelves, panels and so forth. The equipment typically includes management assemblies to organize, store, route and connect optical fibers within the network. For example, optical fibers from provider side cables can be routed and optically connected to optical fibers of subscriber side cables using such assemblies. The assemblies can include features for supporting optical fiber splices, ferrules, connectors, adapters, splitters, wave division-multiplexers and so forth. In addition, the assemblies can include features for storing and protecting optical fibers.

The assemblies can include fiber management trays, which can be used to, e.g., support splices and other fiber management components between incoming and outgoing optical fibers that are routed onto the trays. A typical fiber management organizer assembly can include a support structure to which multiple fiber management trays are pivotally mounted in a stack. The pivoting permits access to a desired one of the stack of trays.

### SUMMARY

In general terms, the present disclosure relates to improvements in versatility of telecommunications equipment, such as telecommunications closures.

In further general terms, the present disclosure is directed to aspects of a fiber management organizer assembly (or “organizer”) of a telecommunications closure.

In further general terms, the present disclosure is directed to a support structure of an organizer of a telecommunications closure that can interchangeably support different types of modules, including modules for pivotally supporting fiber management trays, and modules that include adapters for receiving optical fiber connectors.

The adapters can be arranged as a patch panel, e.g., a block or bank of optical fiber adapters configured to receive optical fiber connectors (e.g., connectors that terminate patch cords) to establish optical connections between the fibers (e.g., fibers of patch cords) that are connectorized by the connectors.

In further general terms, the present disclosure is directed to a method of customizing an organizer of a telecommunications closure by selecting one or more fiber management tray support modules and/or one or more patch panel modules including mounting locations defined by a frame of the organizer, wherein each mounting location is configured to interchangeably mount a fiber management tray support module or an adapter module.

According to certain specific aspects of the present disclosure, an optical fiber management organizer for telecommunications equipment, includes: a frame, the frame defining module mounting locations for mounting modules to the frame in a row; a first module including a first body configured to be mounted to any of the mounting locations, the first body being configured to pivotally support fiber management trays; and a second module including: a second body configured to be mounted to any of the mounting locations; and adapters fixed to the second body, the adapters configured for receiving pairs of optical fiber connectors.

According to further specific aspects of the present disclosure, a method includes: providing a frame of an optical fiber management organizer for telecommunications equipment, the frame defining module mounting locations for mounting modules to the frame in a row; and mounting a first module to one of the mounting locations, the first module including: a first body configured to be mounted to any of the mounting locations; and adapters fixed to the first body, the adapters configured for receiving pairs of optical fiber connectors.

According to further specific aspects of the present disclosure, an adapter holder, includes: a plate for mounting an adapter for optically connecting connectorized optical fibers, the plate defining an opening and notch adjacent the opening, the notch being configured to lockingly engage a spring latch of the adapter when the adapter is positioned in the opening.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of particular embodiments of the present disclosure and therefore do not limit the scope of the present disclosure. The drawings are not necessarily to scale and are intended for use in conjunction with the explanations in the following detailed description. Embodiments of the present disclosure will hereinafter be described in conjunction with the appended drawings, wherein like numerals denote like elements.

FIG. 1 is a perspective view of example telecommunications equipment that can support an optical fiber management organizer assembly according to the present disclosure.

FIG. 2 is a perspective view of a base of the equipment of FIG. 1 that carries an example organizer assembly that can be housed in the equipment of FIG. 1.

FIG. 3 is a further perspective view of the organizer and the base of FIG. 2.

FIG. 4 is a perspective view of a portion of the organizer and the base of FIG. 2.

FIG. 5 is a further perspective view of the organizer and the base of FIG. 2.

FIG. 6 is a perspective view of an organizer according to the present disclosure that can be housed in the equipment of FIG. 1.

FIG. 7 is an enlarged, perspective view of a portion of the organizer of FIG. 6.

FIG. 8 is a further enlarged, perspective view of the portion of FIG. 7.

FIG. 9 is a further enlarged view of the portion of FIG. 7 with fewer optical fiber connectors and adapters,

FIG. 10 is a partially exploded view of the portion of FIG. 7.

FIG. 11 is a further partially exploded view of the portion of FIG. 7.

FIG. 12 is a perspective view of the fiber management tray support module of the organizer of FIG. 6.

FIG. 13 is a further perspective view of the fiber management tray support module of FIG. 12.

FIG. 14 is a perspective view of the fiber management tray of the organizer of FIG. 6,

FIG. 15 is a further perspective view of the fiber management tray of FIG. 14.

FIG. 16 is a perspective view of one of the patch panel modules of the organizer of FIG. 6.

FIG. 17 is a further perspective view of the patch panel module of FIG. 16.

FIG. 18 is a perspective view of the other two patch panel modules of the organizer of FIG. 6.

FIG. 19 is a further perspective view of the two patch panel modules of FIG. 18.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Any examples set forth in this specification are not intended to be limiting and merely set forth some of the many possible embodiments for the claimed invention.

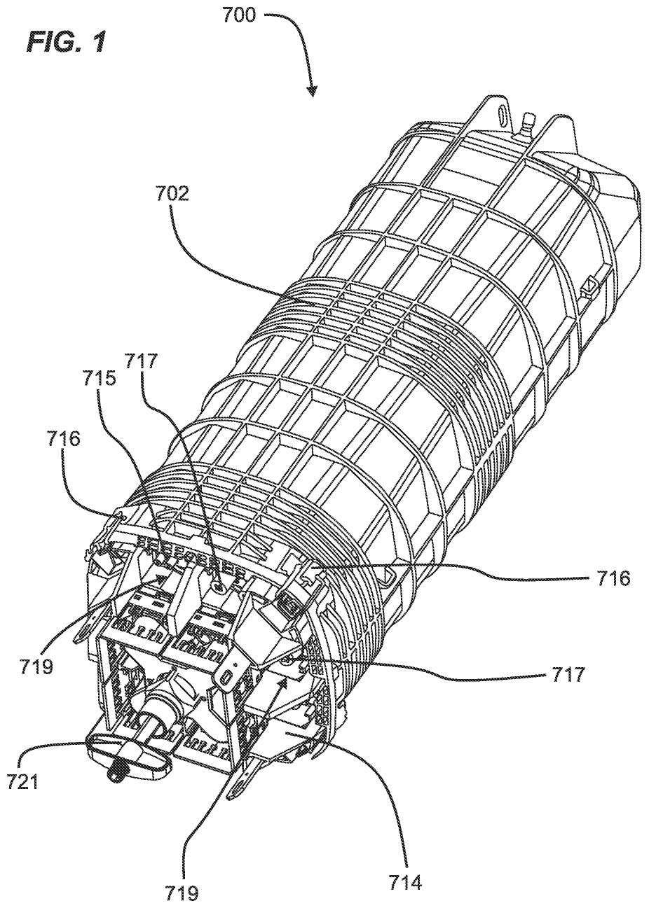

FIG. 1 is a perspective view of example telecommunications equipment 700. The equipment 700 includes a scalable and re-enterable closure. In other examples, the equipment can include other components at a distribution location of an optical fiber network. Such equipment can include, for example, a cabinet, a drawer, a shelf, or a panel for organizing and routing optical fibers.

The closure 700 includes a housing piece 712 (in this case, a cover, such as a dome cover), and an organizer base 714 configured to cooperate with the housing piece 712 to define a sealable and re-enterable telecommunications closure for managing optical fibers. The housing piece 712 defines an interior closure volume in which other fiber managing equipment can be housed, such as an organizer.

Clamps 716 can be used to connect and hold together the cover 712 and the base 714. An actuator 721 can be rotated to compress sealing elements around the cables entering the closure and/or to compress a seal element between the housing pieces.

Cables (such as cables 715 and 717) carrying optical fibers can enter the closure volume via sealable ports 719 defined by seal blocks supported on the base 714. Such cables can include, for example, feeder cables, branch cables, and distribution cables (also known as drop cables). Likewise, electrical grounding conductors or cables can sealingly enter the closure in the same manner.

Typically, optical fibers from one cable entering the closure are spliced or otherwise connected to optical fibers of one or more other cables entering the closure to establish an optical signal path at the closure 700 (or other signal distribution equipment) from a provider side cable to one or more customer side cables. In this manner, optical signals can be transmitted from one cable to another cable via the closure 700, e.g., from a feeder cable to a drop cable, from a feeder cable to another feeder cable (that feeds another closure), from a feeder cable to a branch cable (which branches out to multiple other terminals), etc.

In addition to splicing optical fibers and supporting the optical fiber splices, and in addition to establishing optical connections with connectorized fibers and adapters, other fiber management activities can be performed with an organizer carried on the base 714 and housed within the closure volume defined by the cover 712. Such activities can include, without limitation, indexing fibers, storing fibers (typically in one or more loops) splitting optical signals of fibers, and establishing optical connections with connectorized fibers and adapters, etc.

Splices, such as mechanical splices or fusion splices, can be performed at the factory or in the field, e.g., at the closure 700 positioned in the field. Connector to connector connections can be performed with, e.g., patch cords, which are connectorized optical fiber cables, typically with one end or both ends of the cable connectorized with a fiber optical connector (such as a SC connector, a LC connector, a MPO connector, etc.). Such connectors can, but need not, include ferrules that terminate fibers supported in a connector housing or body. Alternatively, the connector can be ferruleless.

The cables entering the closure can include fibers of different configurations such as loose fibers and fiber ribbons. The fiber ribbons can be flat ribbons or rollable ribbons. The loose fibers can be individual fibers or bundled loose fibers protected by a common protective sheath or tube. For fiber ribbons, the fibers of the entire ribbon can be spliced to the fibers of a corresponding fiber ribbon at the same time, e.g., using a mass fusion splicing procedure.

Splice bodies protect the splices both in the case of individual fiber splices and mass fiber splices, such as mass fusion splices. The splice bodies are held in splice holders also known as splice chips. Fiber management trays can support such splice holders (or chips). The fiber management trays can be stacked in stacks to support modules mounted to a frame all housed within the closure volume. The trays are pivotal relative to the support modules such that a desired tray in the stack can be accessed by pivoting one or more of the trays away from the desired tray.

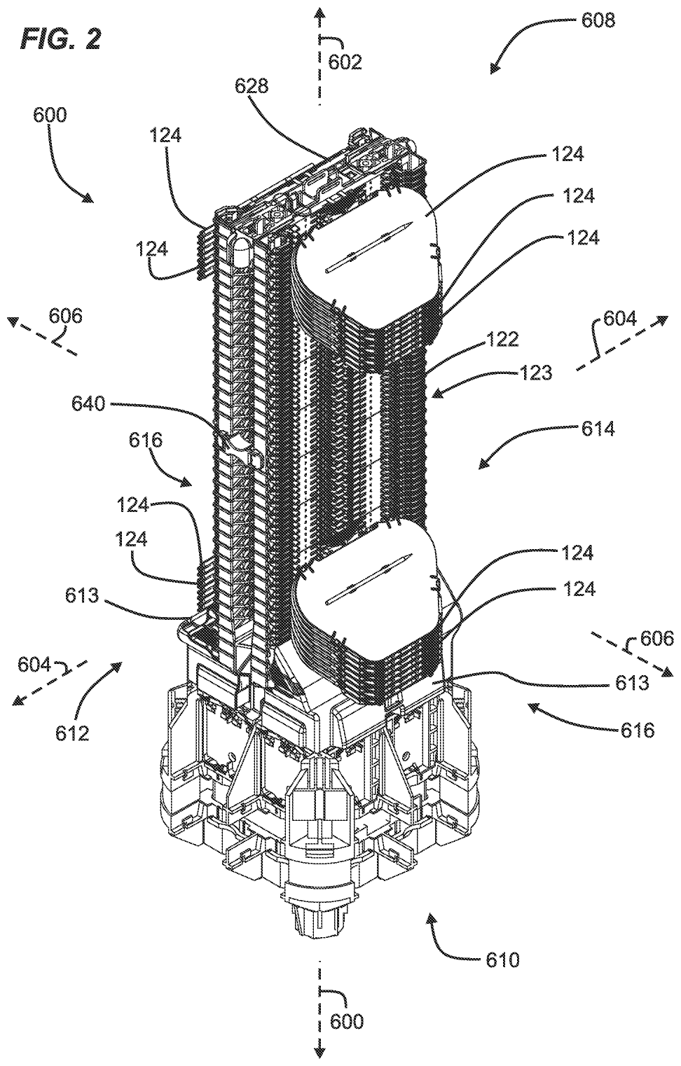

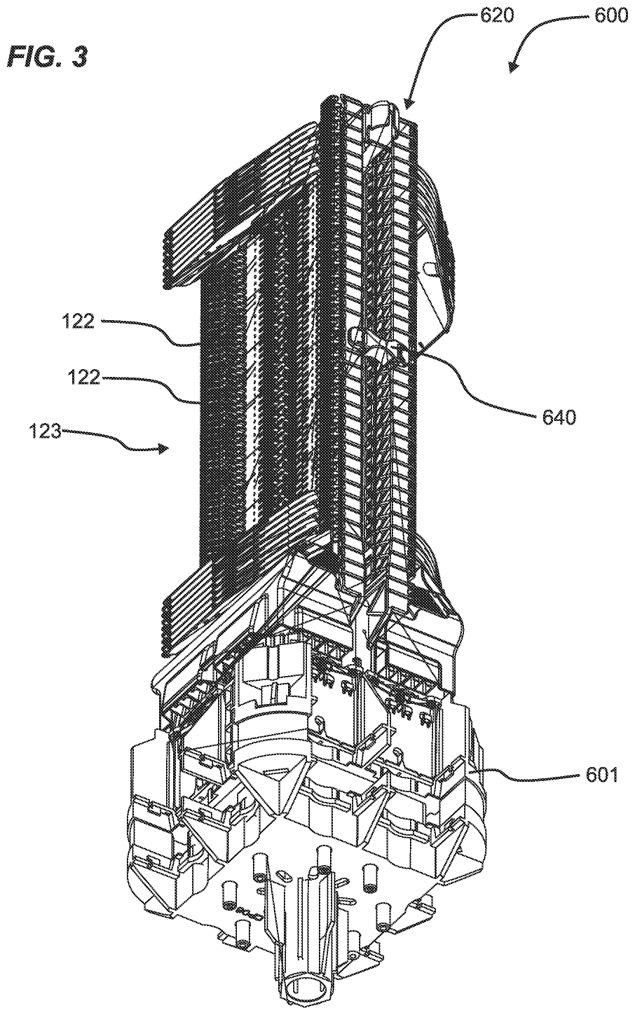

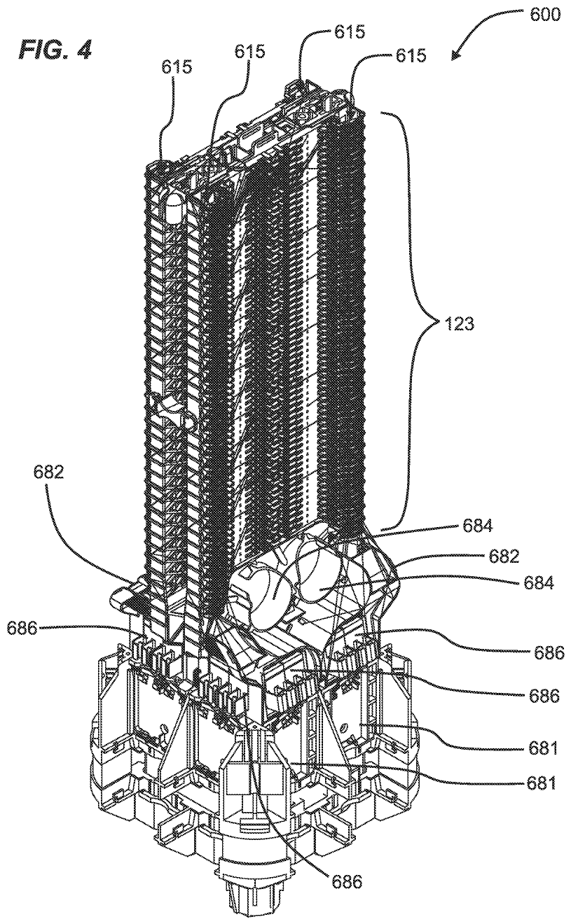

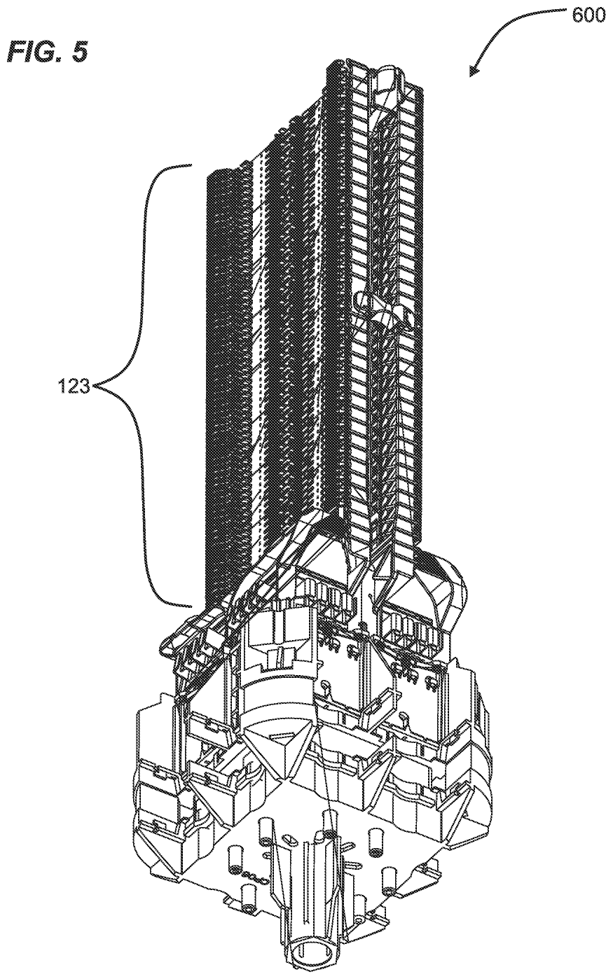

Referring to FIGS. 2-5, a fiber management organizer assembly (or, simply, organizer) 600 that can be housed in the closure 700 of FIG. 1, will be described. In addition, components of the organizer 600 can be installed on or in other telecommunications equipment that are not scalable closures, such as cabinets, panels, drawers, shelves, racks and so forth.

The organizer 600 is carried on a base 601 which, in some examples, can correspond to the base 714 of FIG. 1.

Components of the organizer 600 are configured to be all snappingly connected to one another, which can dramatically shorten assembly times as compared with, e.g., using staking, rivets, or other fasteners.

The organizer 600 defines a first axis, or vertical axis 602, a second axis 604, and a third axis 606. The first axis 602, the second axis 604, and the third axis 606 are mutually perpendicular. The second axis 604 and the third axis 606 define a horizontal plane. The organizer 600 extends from a top 608 to a bottom 610 along the first axis 602. The organizer 600 extends from a first side 612 to a second side 614 along the second axis 604. The organizer 600 extends from a front 616 to a back 618 along the third axis 606.

As used herein, terms such as vertical, horizontal, up, down, left, right, front, back, forward, backward, above, below, and so forth are used for convenience in describing relative positioning of components of an assembly. These terms are not intended to limit how the assembly or components thereof may be situated in practice.

The organizer 600 includes a framework (or frame) 620 consisting of a number of frame members.

The organizer 600 also includes front and back stacks 123 of fiber management tray support modules 122. The stacks 123 are back-to-back mounted to the framework 220 by snap-connect interfaces. Between the stacks 123 is a storage area for looped fibers. In other examples, only one stack of tray support modules is provided on either the front or the back of the framework, and a fiber loop storage basket can be provided on the other of the front or the back of the framework.

In some examples, the frame 620 can be added to along the vertical axis 602 to accommodate additional modules 122.

The frame 620 is snap-connected to the base 601, and includes a top member 628, two side members (also referred to as uprights or module support members) 632 having a first configuration, and two side members (also referred to as uprights or module support members) 634 having a second configuration.

When assembled in the framework 620, each stack 123 of modules 122 is mounted to a pair of the uprights. In the assembled framework configuration, pairs of the uprights are snappingly connected to each other.

The framework 620 can include spacer members 640, for providing additional structural support and maintaining constant spacing between the uprights for storing fiber loops.

Each of the components of the framework 620 just described can be constructed from a suitably strong and rigid material that can readily accommodate snappable couplers. For example, all of the components can be constructed from a polymeric material.

The snappability of all of the members of the framework 620 to one another provides a simple and convenient framework assembly method that does not require additional tools unlike, for example, riveting or staking. That is, the framework 620 advantageously can be assembled entirely by hand, without additional tools (such as a riveting tool or a staking tool).

The uprights 632, 634 include complementary couplers for snappingly connecting a pair of the uprights 632 and 634 to each other, as well as to the base 601 and to the top member 628.

Once a pair of uprights 632 and 634 has been snapped together, the pair can be inserted as a subassembly into snap-connect engagement with the base 601 into a pocket defined by the base 601.

Once the uprights 632, 634 have been snap-connected to the base 601, or before doing so, two sets of uprights pairs 632 and 634 can be snap-connected to the same top member 628.

The base 601 also supports seal blocks (e.g., blocks of gel) for sealing around cables entering the closure. Such seal blocks can be pressurized (e.g., with a spring mechanism) against the walls of the base 601 and the cover 712 (FIG. 1) to form seals around cables entering the enclosure.

Optionally, covers 613 can be provided to cover and protect fiber routing modules 682 (and thereby the fibers routed on the fiber routing module). The covers 613 can be configured to snap-connect to the fiber routing modules 682. The fiber routing modules 682 are snap connected to the frame 620 below the stacks of modules 122 and above baseplates 681 arranged around the axis 602. The baseplates 681 are configured to mount cable fixation subassemblies.

Optionally, each fiber routing module 682 defines fiber routing structures 684 for guiding optical fibers to different sides of a given fiber management tray 124, for example. In addition, each fiber routing module 682 can support sheath holders 686. Such sheath holders 686 can hold protective sheaths or tubes containing optical fibers extending from cables passing through the seal blocks supported in pockets of the base 601 and fixed to the baseplates 681.

Once on the fiber routing module 682, the fibers can emerge from ends of the sheaths and be routed along pathways defined by the routing module 682, including, optionally, about the routing structures 684, and then up routing channels 615 defined by the uprights 632, 634 and the tray support modules 122 to a specific tray 124 supported by a tray support module, on which the fiber is managed as needed (e.g., with a splice to a fiber of another cable entering the closure, with the splice being held on the tray). In addition, some fibers can remain in the protective sheaths and are routed to the interior loop storage volume between the stacks of the tray support modules. In addition, some fibers can have portions routed exteriorly to the frame 620 through guidance features of the top member 628.

Each fiber routing module 682 is configured to snappingly connect to both pairs of uprights 632 and 634. In some examples, the fiber routing module 682 is snappingly connected to the framework 620 after the uprights 632, 634 have been snappingly connected to each other and the pairs of uprights have been snappingly connected to the base 626.

Thus, in one example use case of the closure 700 of FIG. 1 in which is housed the organizer 600 of FIG. 2, optical cables pass through sealed ports defined by seal blocks supported by the base 601 and into the interior volume of the closure, the cables' jackets are terminated and fixed to cable fixation subassemblies mounted to one or more of the baseplates 681 and, from there, optical fibers carried by the cables extend to other parts of the organizer, such as to the modules 122 and fiber management trays 124 pivotally supported by the modules, via the guide channels 615, which are defined by the cooperation of the modules 122 and the uprights 632, 634 to which they are attached.

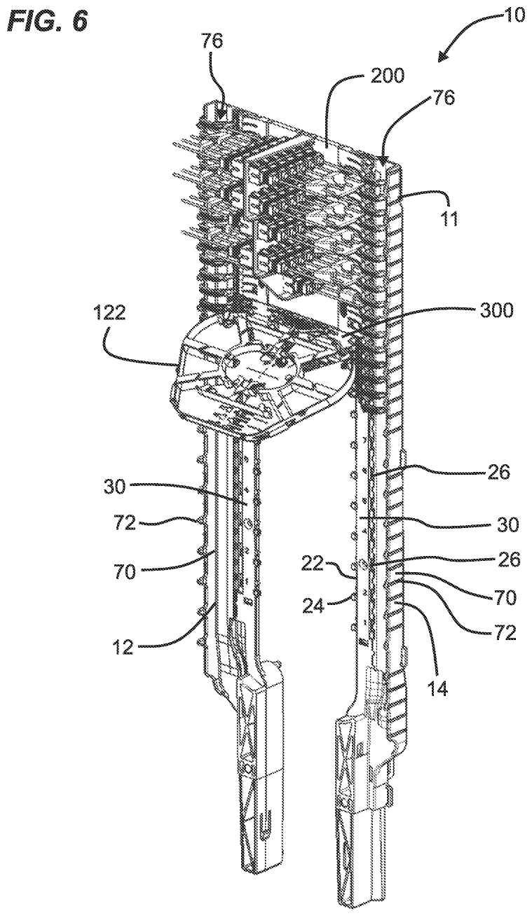

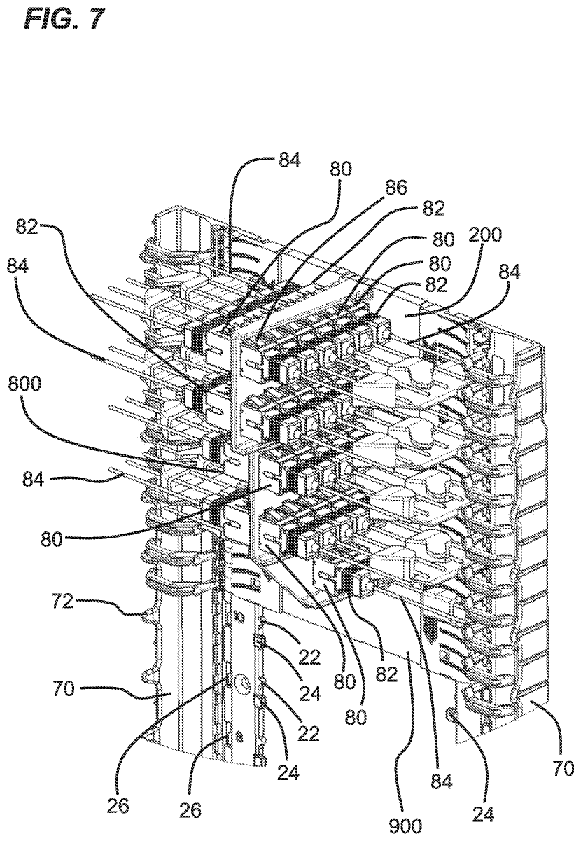

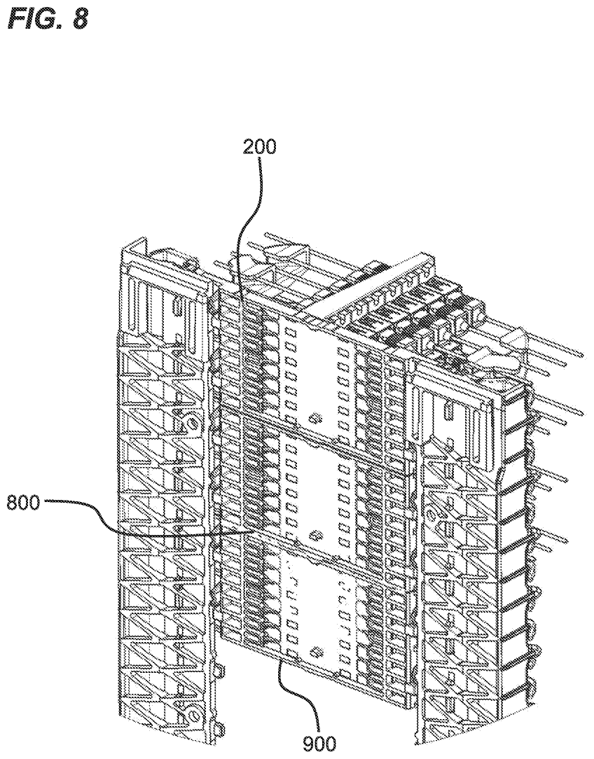

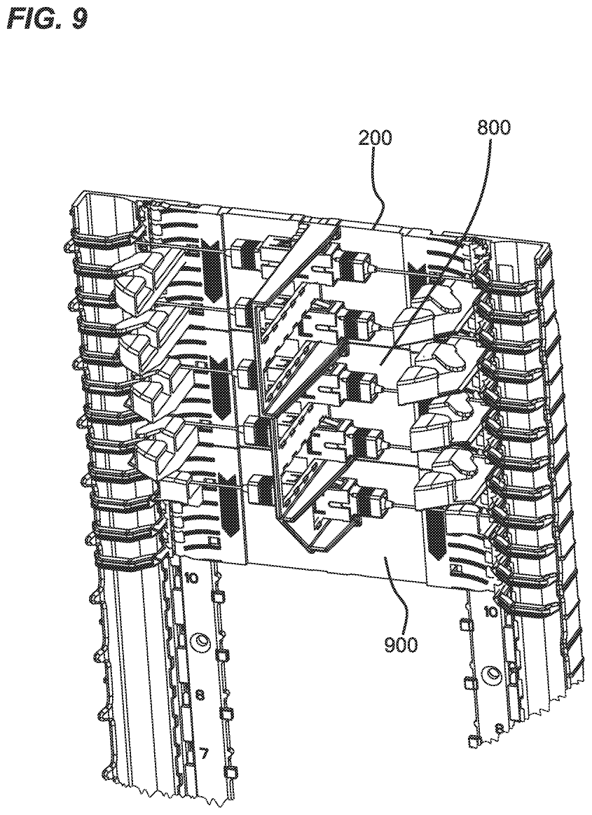

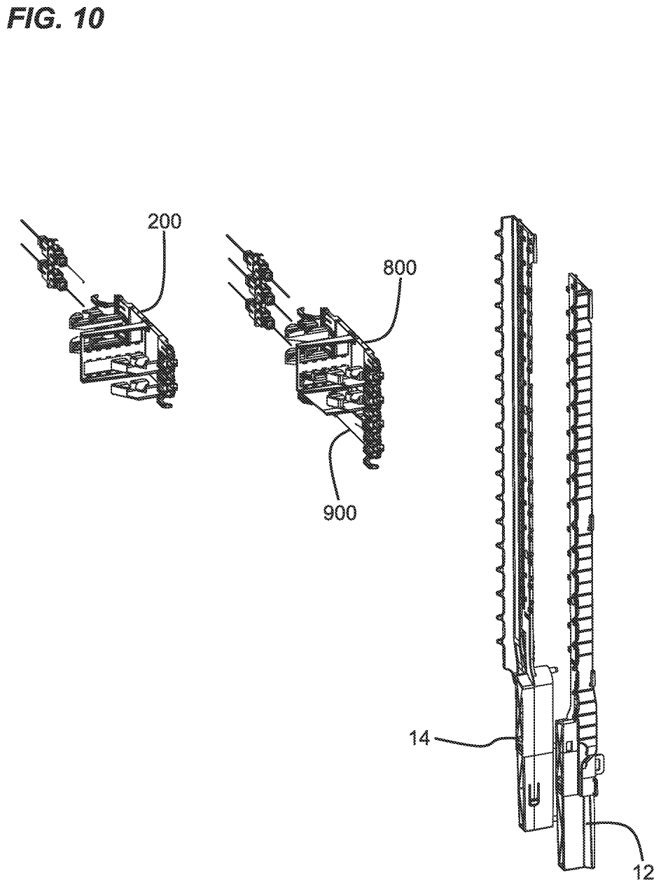

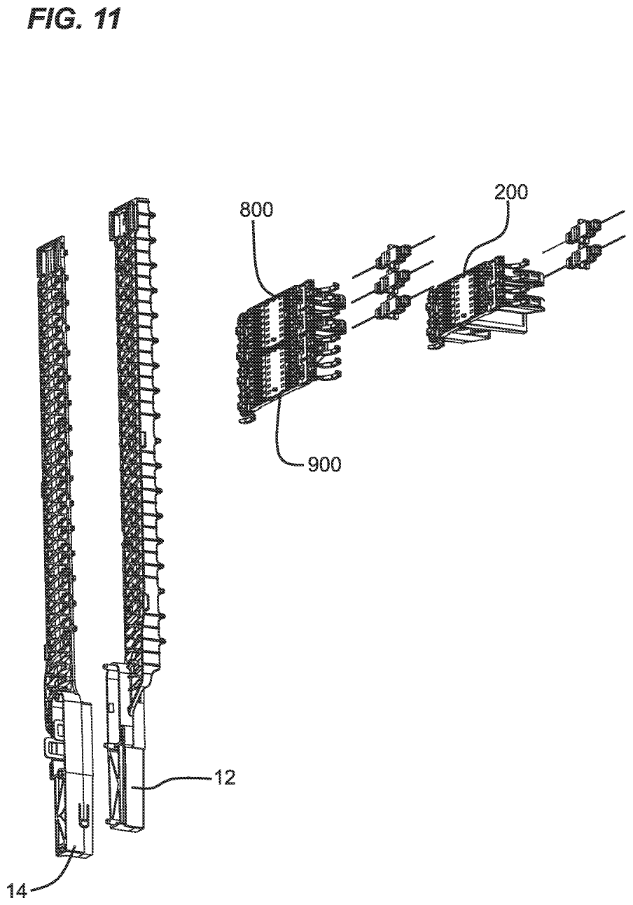

Referring to FIGS. 6-11, an organizer 10 will be described. The organizer 10 includes a portion of a framework of a larger organizer that can be housed in a closure, such as the closure 700 (FIG. 1.). Thus, for example, though the organizer 10 includes just two uprights 12 and 14 forming a frame 11, a larger frame can be constructed with two additional uprights 12 and 14, spacer members, a top member and a base (such as the base 601), as described with respect to the organizer 600 above.

The uprights 12 and 14 serve the same function as the uprights 632 and 634 described above.

The organizer 10 has features that improve the versatility of fiber management that can be supported by the frame 11. For example, the uprights are configured to support different types of fiber management modules, including, e.g., patch panel modules 200, 800, and 900, and a tray support module 300. The tray support module 300 serves the same function as the module 122 discussed above.

Each of these modules 200, 300, 800, 900 can be mounted to any of the mounting locations defined by the uprights 12 and 14. Thus, the organizer 10 can be customized to accommodate different combinations and numbers of optical splice connections between fibers and optical connector to connector connections of patch cords. For example, six patch panel modules can be mounted to the uprights 12, 14, or five patch panel modules and one splice tray support module, or four five patch panel modules and two splice tray support modules, or any other suitable combination, including zero or more of one type of module and zero or more of the other type of module up to the maximum total number of modules that can be mounted to the uprights 12, 14. The selected modules are mounted to the uprights 12, 14 along vertical row of the modules. The modules can, but need not, abut one another in the row, depending on the specific mounting locations selected.

As mentioned, each of the modules 200, 300, 800, 900 is configured to snap-connect to the frame 11. Advantageously, the interfaces for mounting each of the modules 200, 300, 800, 900 to a mounting location of the frame 11 can be structurally identical and on an opposite side of the module as the tray support or adapter support features. The interface allows each module 200, 300, 800, 900 to be installed on the frame 11 in only one orientation, thereby facilitating assembling of the organizer 10 and, e.g., minimizing improper assembling of the organizer 10.

The frame 11 defines interface features for mounting the modules 200, 300, 800, 900. The interface features include vertical row arrangements of ribs 22, tabs 24, and slots 26. The slots 26 are elongate parallel to the vertical dimension. The ribs 22 have curved surfaces and protrude in directions perpendicular to the vertical axis. The tabs 24 project frontwards from surfaces 30 of the uprights 12, 14.

Each module 200, 300, 800, 900 includes structures 314 that defines curved recesses 312. Each module 200, 300, 800, 900 includes hooks 318. Each module 200, 300, 800, 900 includes retainers 316.

To install a module 200, 300, 800, 900 on the frame 11, the hooks 318 enter the slots 26, and then the module 200, 300, 800, 900 can be slid downward into snap-lock engagement with the frame 11. For example, the structures 314 can resiliently flex until the ribs 22 snappingly engage the recesses 312. In addition, to further augment the strength of the mounting interface between the module 200, 300, 800, 900 and the frame 11, the tabs 24 are received in the retainers 316 (which are closed at their top ends) as the module 200, 300, 800, 900 is slid downward and the hooks 318 hook over the frame 11 below the slots the hooks are received in.

Due to the configurations of the hooks 318 and the retainers 316, the module 200, 300, 800, 900 can be snap-lockingly mounted to the frame 11 in only one orientation.

Each patch panel module 200, 800, 900, including all of its features, can be of unitary (e.g., seamless) construction. For example, each patch panel module 200, 800, 900 can be molded as a single part. Each module can be constructed of any suitably strong materials, such as plastic and/or metal,

Each patch panel module 200, 800, 900 includes, respectively, a body 250, 850, 950 defining a main support surface 252, 852, 952. From each main support surface 252, 852, 952 extends, forwardly or rearwardly, a panel, 254, 854, 954. Each panel 254, 854, 954 serves as an adapter holder and includes a plate that defines one or more openings 256, 856, 956, which can be fully enclosed in some examples. The plate of each panel 254, 854, 954 can include one more notches 258, 858, 958 arranged in pairs on opposite sides of each opening 256, 856, 956. In some examples, the notches are recesses that do not extend through a thickness of the plate.

From each main support surface 252, 852, 952 extends, in the same direction as the panel 254, 854, 954, one or more pairs of structures 260, 860, 960 on opposite sides of the panel 254, 854, 954. Each structure 260, 860, 960 includes one or more fiber guides (e.g., hooked structures) 262, 862, 962. The number of fiber guides 262, 862, 962 can be proportional to the number of optical fiber adapters (or, simply, adapters) that can be accommodated in the corresponding opening 256, 856, 956. For example, some of the structures 260, 860, 960 can include one fiber guide, while others can include two or more fiber guides. The fiber guides are generally aligned with fibers extending from connectors installed adapters that are themselves installed in the openings 256, 856, 956.

Each patch panel module 200, 800, 900 also includes, at the extremes of its sides, vertical rows of fiber guide channel defining members 270, 870, 970. These guide channel defining members can be, e.g., hooked fingers. When installed on the frame 11, the members 270, 870, 970 cooperate with complementary members 70, 72 of the frame 11 to define vertical guide channels 76 on opposite sides of the organizer for guiding connectorized optical fibers, or patch cords, from the cable fixation region or the sheath holder region of the organizer to a desired module 200, 800, 900.

Each opening 256, 856, 956, supports a number of optical fiber adapters 80 in a frontward or backward extending row of one or more such adapters. Each adapter 80 can slide into an opening 256, 856, 956 and locks via engagement of spring latches 86 with the notches 258, 858, 958 such that the adapters 80 are fixed relative to the body 250, 850, 950 of the module 200, 800, 900. Thus, the notches 258, 858, 958 can serve as receivers to lockingly engage the spring latches 86. In addition, the notches 258, 858, 958 can serve as locators for locating the correct locking position for an adapter within a plate of a panel. Each adapter 80 supports two optical fiber connectors (such as connectors 82) carrying and terminating one or more optical fibers (such as optical fibers 84) which can be routed to the selected module 200, 800, 900, via the guide channels 76 and then the fiber guides 262, 862, 962 to the appropriate adapter location. The adapter 80 aligns and supports the connectors 82, thereby providing an optical connection between the fibers 84 of the two connectors 82.

Different ones and numbers of the modules 200, 800, 900 can be selected based on the patch panel capacity desired for the organizer 10. That is, the patch panel capacity of the organizer 10 can be customized based on the number and of types of the modules 200, 800, 900 selected for mounting to the frame 11. In addition, by providing modularized patch panel capabilities to the same frame that can also support fiber management tray modules, the organizer overall can support many more patch connections than, for example, organizers in which patch connections are arranged on fiber management trays or other portions of the organizer. In addition, by providing modularized patch panel module capabilities, the customizability of positioning of patch panels on an organizer of a closure can be improved.

The module 200 can support up to, e.g., twelve adapters 80. The module 800 can support up to, e.g., ten adapters 80. The module 900 can support up to, e.g., two adapters 80. Patch panel modules can be constructed to support more adapters.

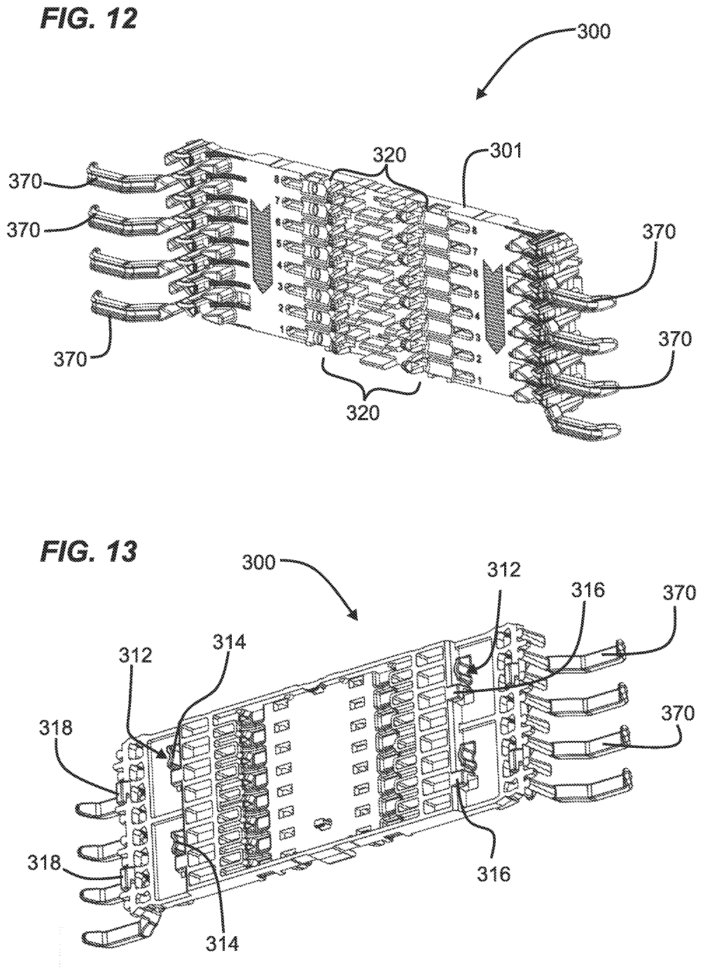

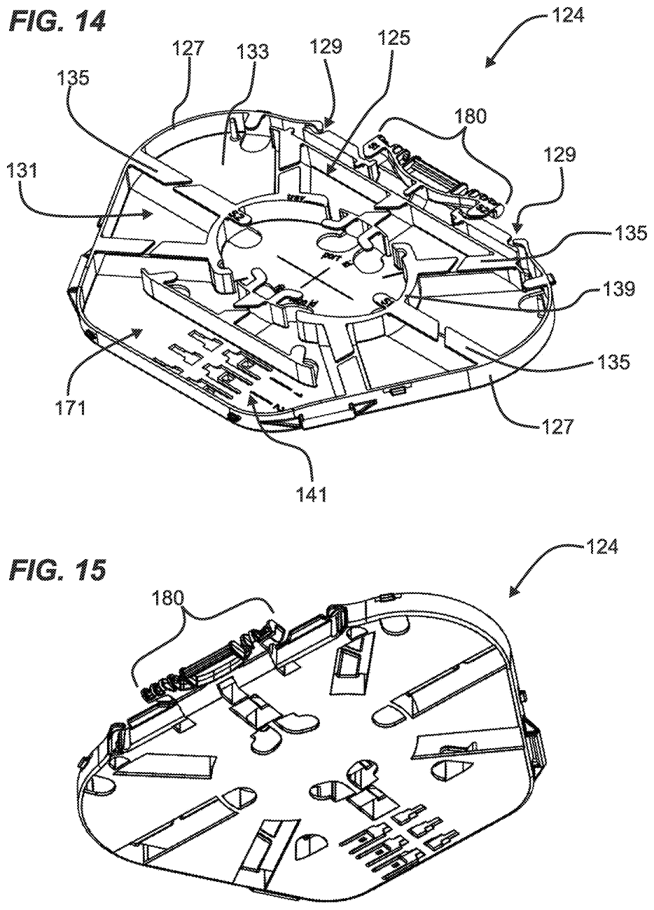

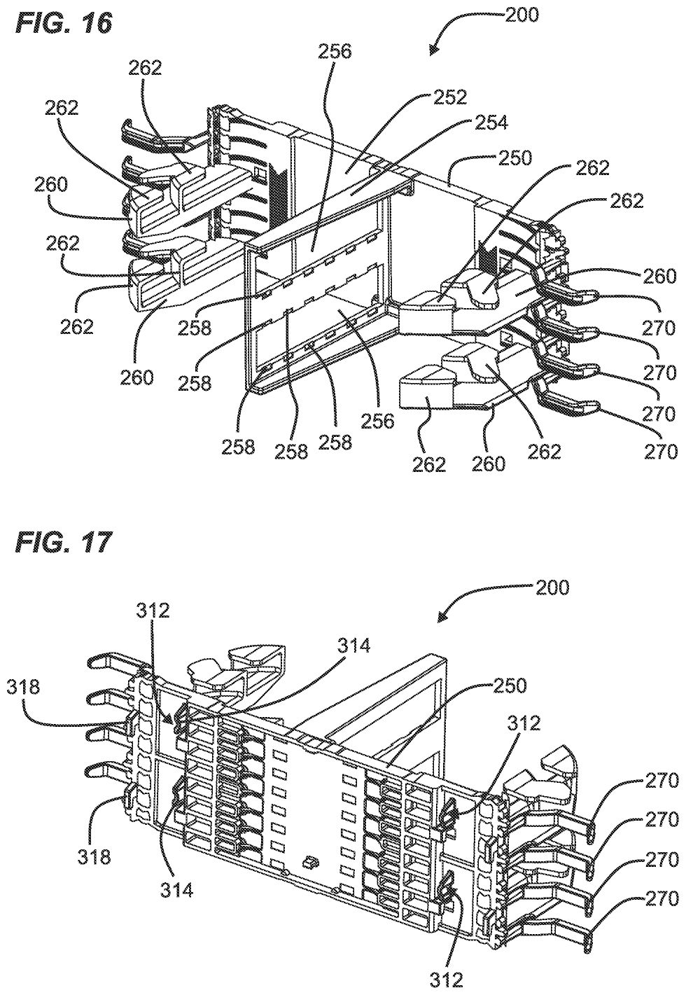

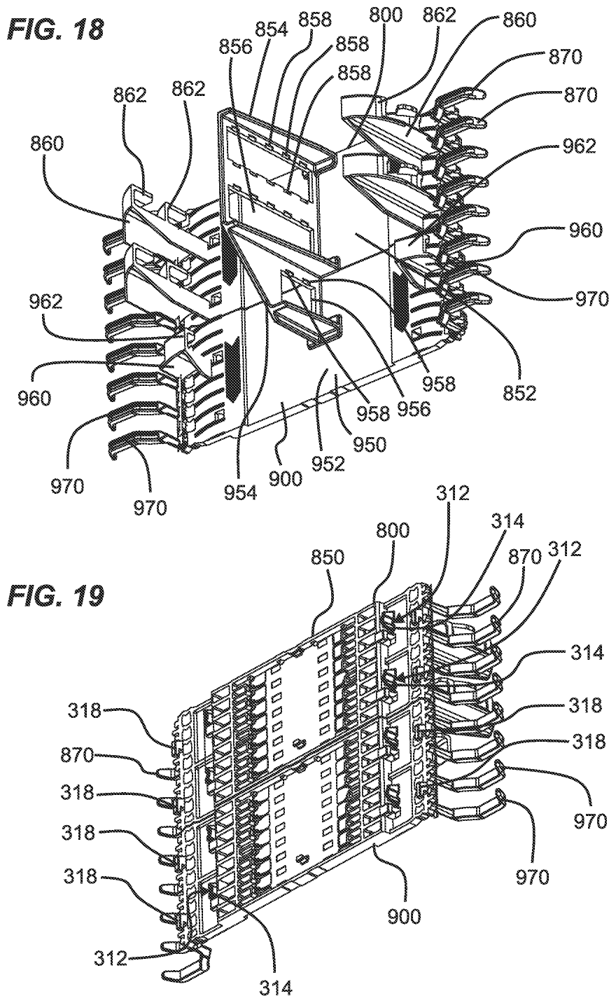

Referring to FIGS. 12-15, each fiber management tray module 300 includes a body 301 that includes the interface features 312, 314, 316, 318 described above. The body 301 also includes a vertical row of coupler arrangements 320. Each coupler arrangement is configured to pivotally receive and support a complementary coupler arrangement 180 of a fiber management tray 124, such that a stack of pivotally mounted trays can be supported by the module 300, with trays being pivotable relative to other trays to provide access to the other trays. Each body 301 also includes, at the extremes of its sides, vertical rows of fiber guide channel defining members 370. These guide channel defining members can be, e.g., hooked fingers identical to those of the bodies of the modules 200, 800, 900. When installed on the frame 11, the members 370 cooperate with complementary members 70, 72 of the frame 11 to define vertical guide channels on opposite sides of the organizer 10 for guiding optical fibers from the cable fixation region or the sheath holder region of the organizer to a desired module 300 and tray 124, where that fiber can be managed.

Each tray 124 can include a fiber management region 171 and a fiber routing and storage region 125, both surrounded by an outer perimeter wall 127 with entryways 129 via which fibers can enter the interior 131 of the tray 124 defined between a main fiber management surface 133 and fiber retainers 135 extending from the wall 127. The fiber management region 171 can support one or more fiber management components (e.g., mounted at mounting structures 141), such as adapters (for connectorized fibers), splice holders (for spliced fibers) and splitters (for splitting fibers). The region 125 includes one or more structures 139 for looping fibers (for slack storage) and directing fibers to one or another side of the fiber management region 171, as needed.

Various modifications and alterations of this disclosure will become apparent to those skilled in the art without departing from the scope and spirit of this disclosure, and it should be understood that the scope of this disclosure is not to be unduly limited to the illustrative examples set forth herein.

What is claimed is:

1. An optical fiber management organizer for telecommunications equipment, comprising:
a frame, the frame defining module mounting locations for mounting modules to the frame in a row;
a first module including a first body configured to be mounted to any of the mounting locations, the first body being configured to pivotally support fiber management trays; and
a second module including:
a second body configured to be mounted to any of the mounting locations; and
adapters fixed to the second body, the adapters configured for receiving pairs of optical fiber connectors,

2. The organizer of claim 1, wherein the second body includes a panel extending from a surface of the second body in a direction perpendicular to the row.

3. The organizer of claim 2, wherein the panel defines an opening and notches for receiving and locking adapters.

4. The organizer of claim 3, wherein the opening is configured to receive adapters in a row of adapters that is perpendicular to the row of the modules.

5. The organizer of any of claims 1-4, wherein the second body includes fiber guide channel members configured to cooperate with fiber guide channel members of the frame to define fiber guide channels.

6. The organizer of any of claims 2-5, wherein the second body includes optical fiber guides for guiding optical fibers to the panel.

7. The organizer of any of claims 1-6, wherein each of the first module and the second module are configured to snap-connect to the frame in only one orientation.

8. The organizer of any of claims 1-7, further comprising the first module and the second module mounted to the frame and abutting each other.

9. The organizer of claim 8, further comprising a fiber management tray pivotally supported by the first module.

10. The organizer of claim 9, further comprising a fiber splice held by a splice holder positioned on the tray.

11. The organizer of any of claims 1-10, further comprising an optical fiber adapter installed on the second module.

12. The organizer of claim 11, further comprising connectorized optical fibers installed in the adapter.

13. A telecommunications closure, comprising:
a housing defining a sealable and re-enterable closure volume; and
the organizer of any of claims 1-12 positioned in the housing.

14. The closure of claim 13, further comprising cables carrying optical fibers entering the closure volume via sealed ports, wherein jackets of the cables are fixed relative to the organizer.

15. The organizer of any of claims 1-12, wherein the first module and the second module have interfaces for connecting to the frame, respectively, the interfaces being of identical construction.

16. A method, comprising:
providing a frame of an optical fiber management organizer for telecommunications equipment, the frame defining module mounting locations for mounting modules to the frame in a row; and
mounting a first module to one of the mounting locations, the first module including:
a first body configured to be mounted to any of the mounting locations; and
adapters fixed to the first body, the adapters configured for receiving pairs of optical fiber connectors.

17. The method of claim 16, further comprising:
mounting a second module to another of the mounting locations, the second module including a second body configured to pivotally support fiber management trays.

18. The method of any of claims 16-17, further comprising:
removing the first module from the frame and mounting a third module to the one of the mounting locations, the third module including a third body configured to pivotally support fiber management trays.

19. The method of any of claims 17-18, wherein the first module, the second module, and the third module have interfaces for connecting to the frame, respectively, the interfaces being of identical construction.

20. The method of claim 16, further comprising installing optical fiber connectors terminating optical fibers into one of the adapters.

21. An adapter holder, comprising:
a plate for mounting an adapter for optically connecting connectorized optical fibers, the plate defining an opening and notch adjacent the opening, the notch being configured to lockingly engage a spring latch of the adapter when the adapter is positioned in the opening.

22. The adapter holder of claim 21, wherein the plate includes a pair of the notches configured to locking receive a pair of the spring latches of the adapter.

23. The adapter holder of any of claims 21-22, wherein each notch is a recess that does not extend through a thickness of the plate.

24. The adapter holder of any of claims 21-23, wherein the opening includes a plurality of pairs of the notches such that the opening can lockingly receive a plurality of the adapters in a row.

25. The adapter holder of any of claims 21-24, further comprising the adapter positioned in the opening and lockingly engaged with the notch.

26. An assembly for telecommunications equipment, comprising:
a frame including a plurality of frame members, the frame including interface features including ribs, slots, and tabs, the frame being configured to mount a module including a body having a top, a bottom, a front, and a back, the body including at the back other interface features including structures that define curved recesses configured to snappingly engage the ribs of the frame when the module is slid downward relative to the frame, hooks configured to enter the slots of the frame and hook over the frame when the module is slid downward relative to the frame, and retainers that are closed at top ends of the retainers and are configured to receive the tabs of the frame when the module is slid downward relative to the frame.

27. The assembly of claim 26, wherein the frame members include a pair of spaced apart module support members.

28. The assembly of claim 26, wherein the frame is positioned in a cabinet.

29. The assembly of any of claims 26-28, further comprising the module.

30. The assembly of claim 29, wherein the module includes at extremes of right and left sides of the module, rows of fiber guide channel defining members.

31. The assembly of any of claims 29-30, wherein the module is of seamless, unitary construction.

32. The assembly of any of claims 29-31, further comprising coupler arrangements at the front of the module configured to pivotally receive and support complementary coupler arrangements of fiber management trays.

33. The assembly of any of claims 29-31, further comprising a panel at the front of the module configured as an adapter holder.

34. The assembly of any of claims 26-33, wherein the interface features allow the module to be mounted to the frame in only one orientation.

35. The assembly of any of claims 26-34, wherein the frame members are configured to snap connect to one another.
